(19) United States
(12) Patent Application Publication
(10) Pub. No.: US 2026/0118882 A1
(43) Pub. Date: Apr. 30, 2026

(54) AUTONOMOUS TRAVELING ROBOT HAVING FLOOR SENSING DEVICE

(71) Applicant: SEOROBOTICS CO., LTD., Anyang-si, Gyeonggi-do (KR)

(72) Inventors: Jae Ik SHIM, Seoul (KR); Jong Hyun YOON, Seoul (KR); Young Jun LEE, Hwaseong-si, Gyeonggi-do (KR)

(21) Appl. No.: 19/480,363

(22) PCT Filed: Nov. 25, 2024
(86) PCT No.: PCT/KR2024/018717

§ 371 Date: Oct. 30, 2025

(30) Foreign Application Priority Data
Dec. 1, 2023 (KR) 10-2023-0172258

(51) Int. Cl. G05D 1/622

(52) U.S. Cl. CPC G05D 1/622

(57) ABSTRACT

An autonomous mobile robot equipped with a floor detection device includes: a mounting housing on which wheels and a wheel-driving means are mounted; a driving controller for setting a driving direction and driving path of the autonomous mobile robot, and for controlling driving of the wheel-driving means; and a floor detection device mounted at a central portion of the mounting housing, and configured to generate floor surface state analysis result information from floor surface state information including presence or absence of obstacles, drop-off elements or ramps on a floor surface and transmit the generated information to the driving controller.

### TECHNICAL FIELD

The present invention relates to an autonomous mobile robot equipped with a floor detection device, and more particularly to an autonomous mobile robot equipped with a floor detection device, the floor detection device having a 3D TOF array sensor and an IMU sensor, so that, when traveling on floor surfaces such as roadways, road surfaces, or indoor floors, the presence of obstacles and ramps on the floor surfaces can be determined by calculating information about robot's movement and a robot's path can be reconfigured by identifying drop-off elements like cliffs, thereby enabling stable driving.

### BACKGROUND ART

Generally, although various sensors are used for a robot's fall detection, floor obstacle detection, and ramp determination, the detection is limited, and a plurality of sensors is required for determining the detection area.

Conventionally, the state of a floor surface during travel (e.g., the presence of ramps, drop-offs, and obstacles) was determined by using sensors such as infrared and Position-Sensitive Detectors (PSDs), the installation of which is restricted to a lower part of a robot. However, since this method was limited to merely determining whether the autonomous mobile robot would fall, travel was based on very fragmentary judgments, thereby making stable driving difficult to achieve.

To address this, an improvement was made so that driving control could be achieved by identifying the presence of drop-offs and ramps using 2D or 3D LiDAR. However, when sensing is performed using 2D or 3D LiDAR, detection is limited, and, due to the characteristics of LiDAR requiring installation in a high position, a blind spot is inevitably created in the forward direction during travel, which leads to a problem of reduced reliability of collected information.

In other words, in the case of existing floor detection devices for an autonomous mobile robot, many difficulties were faced in identifying the presence of ramps and floor obstacles, and simultaneously determining the state of the floor during travel.

Consequently, such devices are inevitably exposed to various problems, such as the risk of collision or fall for a small robot on the sides of a ramp, and an increased risk of structural damage due to a reduced contact area with stair edges when traveling on stairs.

The background art or related art described herein is provided only to aid in understanding the technical significance of the present invention and is not intended to imply that it was technology widely known in the technical field to which the present invention pertains prior to the filing of the application for the present invention.

### RELATED ART DOCUMENTS

### Patent Documents

(Patent Document 1) Korean Patent Application Publication No. 10-2009-0119984
(Patent Document 2) Korean Patent Application Publication No. 10-2021-0030296

### DISCLOSURE

### Technical Problem

Therefore, the present invention has been made in view of the above problems, and it is one object of the present invention to provide an autonomous mobile robot equipped with a floor detection device, the floor detection device having a 3D TOF array sensor and an IMU sensor, so that, by calculating information about robot's movement when traveling on floor surfaces such as roadways, road surfaces, or indoor floors to determine the presence of obstacles and ramps, the occurrence of blind spots on the travel path can be prevented, thereby improving the reliability of the floor surface state information.

It is another object of the present invention to provide an autonomous mobile robot equipped with a floor detection device, so that, by determining the presence of drop-off elements, such as a cliff, from sensed floor surface state information, the path of the traveling robot can be reconfigured, thereby enabling stable driving.

However, the objects of the present invention are not limited to the foregoing, and it is to be understood that objects or effects that can be appreciated from the means for solving the problem or the embodiments, even if not explicitly mentioned, are also included herein.

### Technical Solution

In accordance with an aspect of the present invention, the above and other objects can be accomplished by the provision of an autonomous mobile robot equipped with a floor detection device, including: a mounting housing on which wheels and a wheel-driving means are mounted; a driving controller for setting a driving direction and driving path of the autonomous mobile robot, and for controlling driving of the wheel-driving means; and a floor detection device mounted at a central portion of the mounting housing, and configured to generate floor surface state analysis result information from floor surface state information including presence or absence of obstacles, drop-off elements or ramps on a floor surface and transmit the generated information to the driving controller.

In an embodiment, the floor detection device may include: a lower housing formed to have an open front part; a plurality of TOF sensor modules mounted on the lower housing and configured to simultaneously recognize a front of the autonomous mobile robot and a floor surface on which the robot is traveling and to generate and transmit the floor surface state information; an upper housing detachably coupled to the lower housing; an IMU sensor module formed on an upper portion of the lower housing and configured to generate and transmit tilt information of the traveling autonomous mobile robot; and a sensing controller configured to receive and analyze the floor surface state information and the tilt information from the TOF sensor modules and the IMU sensor module, respectively, to generate floor surface state analysis result information and transmit the generated information to the driving controller.

In an embodiment, the lower housing may include: a first module mounting portion on which the plurality TOF sensor modules are mounted to be arranged in a semicircular shape and to be inclined at a predetermined angle; a plurality of first fastening shafts configured to be spaced apart from an inner side of the first module mounting portion by a predetermined interval, for supporting the IMU sensor module such that the IMU sensor module can be detachably coupled; a second fastening shaft configured to pass through the upper housing for detachment from and coupling to the mounting housing; and a lower mounting groove for supporting the sensing controller such that the sensing controller can be mounted and fixed.

In an embodiment, the first module mounting portion may be configured to have an inclination angle of 6° to 9°.

In an embodiment, the TOF sensor modules may include: a module casing inserted into and fixed on the first module mounting portion; a TOF sensor coupled to the module casing and composed of a 3D TOF array sensor; and a mounting flange on which a cable connecting the sensing controller and the TOF sensor is mounted.

In an embodiment, the sensing controller may receive a horizontal position value of the autonomous mobile robot from the IMU sensor module, and receive a difference value between a floor surface on which the robot is traveling and a front direction from the TOF sensor modules, and analyze the received information to determine presence or absence of an obstacle or a ramp on the floor surface on which the robot is currently traveling.

In an embodiment, the sensing controller may receive a tilt value of the autonomous mobile robot from the IMU sensor module, and analyze the received tilt value to determine whether a state of the floor surface is an upward-sloping ramp, a downward-sloping ramp, or a side ramp.

In addition to the technical problems of the present invention mentioned above, other features and advantages of the present invention will be described hereinafter, or will be clearly understood by those of ordinary skill in the art to which the present invention pertains from such description and explanation.

### Advantageous Effects

The present invention as described above provides the following effects.

An autonomous mobile robot equipped with a floor detection device according to the present invention can determine the presence of obstacles and ramps when traveling on floor surfaces such as roadways, road surfaces, or indoor floors by calculating information about robot's movement on the floor surfaces, so that the occurrence of blind spots on the travel path can be prevented, thereby improving the reliability of the floor surface state information.

In addition, the autonomous mobile robot equipped with the floor detection device according to the present invention can reconfigure the path of the traveling robot by determining the presence of drop-off elements such as a cliff from sensed floor surface state information, thereby enabling stable driving.

Furthermore, the various and beneficial advantages and effects of the present invention are not limited to the foregoing, and will be more readily understood in the course of describing the specific embodiments of the present invention.

### DESCRIPTION OF DRAWINGS

FIG. 1 illustrates an exemplary view of an autonomous mobile robot equipped with a floor detection device according to an embodiment of the present invention.

FIGS. 2 and 3 illustrate the perspective views of a floor detection device according to an embodiment of the present invention.

FIG. 4 illustrates the plan view of the floor detection device according to an embodiment of the present invention.

FIG. 5 is an exemplary view illustrating the angle of the viewing direction of a TOF sensor through the autonomous mobile robot equipped with the floor detection device according to an embodiment of the present invention.

FIG. 6 schematically illustrates an obstacle determination state of the autonomous mobile robot equipped with the floor detection device according to an embodiment of the present invention.

FIG. 7 schematically illustrates an example of determination for an upward-sloping ramp by the autonomous mobile robot equipped with the floor detection device according to an embodiment of the present invention.

FIG. 8 schematically illustrates an example of determination for a downward-sloping ramp by the autonomous mobile robot equipped with the floor detection device according to an embodiment of the present invention.

FIG. 9 schematically illustrates an example of determination for a ground surface connected to a downward-sloping ramp by the autonomous mobile robot equipped with the floor detection device according to an embodiment of the present invention.

FIG. 10 schematically illustrates an example of determination for cliff identification by the autonomous mobile robot equipped with the floor detection device according to an embodiment of the present invention.

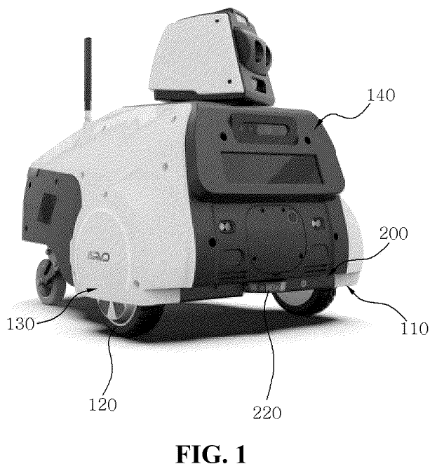

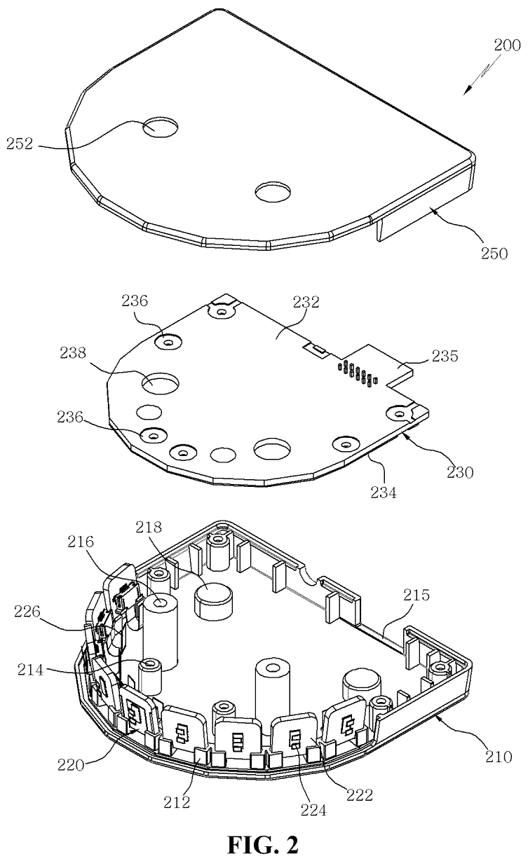

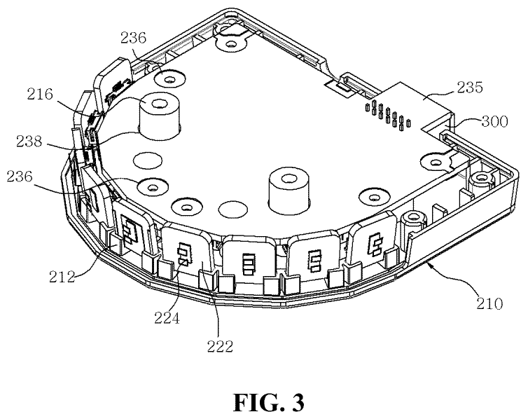

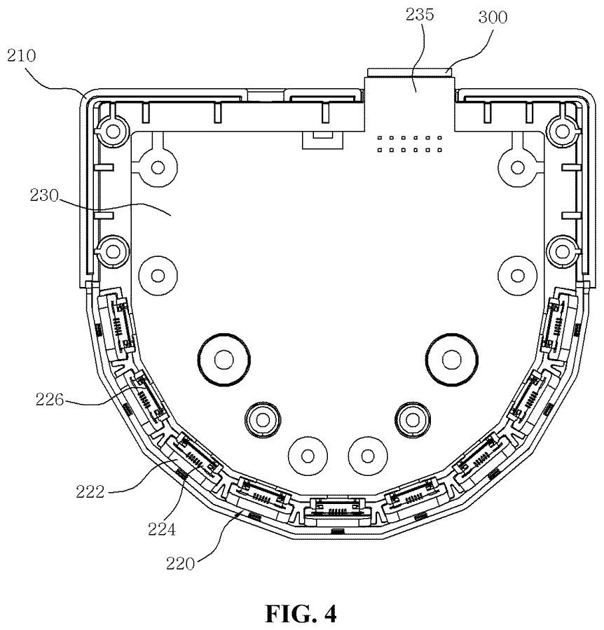

### BEST MODE

Hereinafter, preferred embodiments of the present invention will be described in detail with reference to the accompanying drawings. It is to be noted that in assigning reference numerals to the components of the drawings, the same components are designated by the same reference numerals as far as possible even when they are shown in different drawings.

In addition, in describing the present invention, it should be noted that the technical terms used are merely for the purpose of describing particular embodiments and are not intended to limit the scope of the present invention. Furthermore, when it is determined that a detailed description of a related known configuration or function may obscure the subject matter of the present invention, such a detailed description will be omitted. In addition, in describing the present invention, general terms should be interpreted based on their predefined definitions or the context, and should not be construed in an overly restrictive sense. If a technical term used is an incorrect term that fails to accurately represent the technical idea of the present invention, it should be understood by being replaced with a technical term that a person of ordinary skill in the art can properly understand.

In addition, in describing the present invention, terms such as “comprise,” “constitute,” or “have” are intended to indicate that a corresponding component may be inherent, unless explicitly stated otherwise. These terms should not be interpreted as necessarily including all of a plurality of components or steps, and it should be understood that some of the components or steps may not be included, or additional components or steps may be further included. All terms, including technical or scientific terms, have the same meaning as commonly understood by one of ordinary skill in the art to which this invention belongs, unless otherwise defined.

In addition, in describing the components of the present invention, identifiers such as first, second, A, B, (a), (b), etc., may be used. These identifiers are used to distinguish one component from another for the convenience of description only, and do not limit the essence, turn, or order of the corresponding component.

Further, the suffixes “module” and “unit” for components used in this specification are assigned or used interchangeably solely for the ease of drafting the specification, and do not in themselves have mutually distinct meanings or roles.

### DESCRIPTION OF SYMBOLS

110: mounting housing
120: wheel
130: wheel-driving means
140: driving controller
200: floor detection device
210: lower housing
212: first module mounting portion
214: first fastening shaft
215: lower mounting groove
216: second fastening shaft
218: shock-absorbing slit
220: TOF sensor module
222: module casing
224: TOF sensor
226: mounting flange
230: IMU sensor module
232: module body
234: IMU sensor
235: upper fixing panel
236: module-mounting groove
238: shaft through-hole
250: upper housing
252: shaft-coupling hole
300: sensing controller

### MODE FOR CARRYING OUT THE INVENTION

Hereinafter, embodiments of the present invention will be described in detail with reference to the accompanying drawings.

As shown in the accompanying drawings, the autonomous mobile robot equipped with the floor detection device of the present invention includes a mounting housing 110 including a lower frame and a floor detection device 200 mounted at a central portion thereof; wheels 120 coupled to side parts of the mounting housing 110 and configured to support the travel of the autonomous mobile robot; a wheel-driving means 130 connected to each of the wheels 120 and configured to rotate the wheel 120; a driving controller 140 connected to the floor detection device 200 and the wheel-driving means 130 through a network to set and control whether to drive the wheel 120, a driving direction, and a driving path according to a sensing value transmitted from the floor detection device 200; a plurality of TOF sensor modules 220; and an IMU sensor module 230, wherein the floor detection device 200 generates floor surface state information including the presence or absence of obstacles, drop-off elements, and ramps on a floor surface such as a roadway, road surface, or indoor floor and transmits the generated information to the driving controller 140.

Here, the driving controller 140 may include a display for outputting information about a set driving path.

In addition, the driving controller 140 of the present invention may be configured such that the driving of the wheel-driving means 130 is controlled to regulate the amount of rotation of the wheels 120, based on floor surface state analysis result information received from a sensing controller 300.

The floor detection device 200 includes a lower housing 210 formed to have an open front part; the TOF sensor modules 220, which are mounted on the lower housing 210 and transmit, to the sensing controller 300, floor surface state information regarding the floor surface, on which the autonomous mobile robot is traveling, by irradiating a light source including infrared rays; an upper housing 250 detachably coupled to the lower housing 210 for housing the IMU sensor module 230; the IMU sensor module 230 that is configured on an upper portion of the lower housing 210, to generate the tilt information of the traveling autonomous mobile robot and transmit the tilt information to the sensing controller 300; and the sensing controller 300 that is connected to the TOF sensor modules 220 and the IMU sensor module 230, respectively, via a network. The sensing controller 300 analyzes the floor surface state information and the tilt information of the autonomous mobile robot to generate floor surface state analysis result information, and transmits the floor surface state analysis result information to the driving controller 140 such that the autonomous mobile robot can travel stably according to the state of the floor surface.

In the lower housing 210, a first module mounting portion 212 is formed along the open front part. The plural TOF sensor modules 220 are mounted on the first module mounting portion 212 at an incline.

The first module mounting portion 212 is configured such that the TOF sensor modules 220 are mounted thereon at an incline to allow simultaneous sensing of the front part of the autonomous mobile robot and the floor surface thereof. Preferably, an inclined groove is formed such that a module casing 222 of the TOF sensor modules 220, to be described later, is mounted to be inclined toward a front side of the lower housing 210 as it extends from a lower end to an upper end of the lower housing 210.

Herein, the inclined groove may be configured to have an inclination angle of 6° to 9°, but is not limited thereto.

In addition, a plurality of first fastening shafts 214 are formed in the lower housing 210 to protrude upward along a circumferential surface thereof, wherein the first fastening shafts 214 are configured to be spaced apart from an inner side of the first module mounting portion 212 by a predetermined interval and to support the IMU sensor module 230 such that it can be detachably coupled.

Preferably, a screw thread is formed on each of the first fastening shafts 214 so that a fastening bolt, a screw, or the like can be coupled thereto by a screw-fastening method.

In addition, second fastening shafts 216 are formed in the lower housing 210, the second fastening shafts 216 passing through the upper housing 250 for detachment from and coupling to the mounting housing 110.

Here, the second fastening shafts 216 may pass through both the IMU sensor module 230 and the upper housing 250 to be coupled with the mounting housing 110, but the present invention is not limited thereto.

Meanwhile, in the lower housing 210 of the present invention, a lower mounting groove 215 may be configured on one surface of a rear portion thereof for supporting the sensing controller 300, to be described later, such that the sensing controller 300 can be mounted and fixed.

The lower mounting groove 215 is configured such that a lower surface of the sensing controller 300 can be fixed thereto. Here, a sealing member, which is in close contact with an outer surface of the sensing controller 300, may be further configured in the lower mounting groove 215 along an inner circumferential surface thereof.

A shock-absorbing slit 218 may be further configured in such a lower housing 210. The shock-absorbing slit 218 is configured to allow a shock-absorbing member to be inserted into a central portion thereof and to minimize the transmission of certain vibrations or shocks to the IMU sensor module 230 when the autonomous mobile robot is traveling.

The shock-absorbing slit 218 may be configured to protrude from a rear portion of each of the second fastening shafts 216, and an insertion groove may be formed in an upper central portion thereof so that a shock-absorbing member, such as rubber or a spring, can be inserted.

The plural TOF sensor modules 220 are inserted and fixed on the first module mounting portion 212, which is formed in the lower housing 210, to have a predetermined inclination angle. This configuration allows the modules to simultaneously recognize the front and the floor surface of the autonomous mobile robot, detect the presence or absence of obstacles on the floor surface of the driving path and drop-off elements such as ramps and cliffs formed on the floor surface, and transmit the sensed information to the sensing controller 300.

Each of the TOF sensor modules 220 includes the module casing 222 that is inserted into and fixed on the first module mounting portion 212; a TOF sensor 224 that is coupled to the module casing 222, and connected to the sensing controller 300 to allow for the transmission and reception of sensed information; and a mounting flange 226 on which a cable connecting the sensing controller 300 and the TOF sensor 224 is mounted.

Herein, a sensor-mounting groove is formed in a central portion of the module casing 222 so that the TOF sensor 224 can be mounted therein.

In addition, guide panels may be further configured on both side portions of the module casing 222 for guiding the module casing 222 to be detachably coupled in a sliding manner to the first module mounting portion 212 formed at an incline.

The TOF sensor 224 may be composed of a light-emitting part for emitting a light source including infrared rays, and a light-receiving part for receiving a light source reflected from an object located in front or from the floor surface.

Such a TOF sensor 224 may be a 3D TOF array sensor, but is not limited thereto.

In addition, the module casing 222 may be arranged to have a semicircular shape along a curved portion of the open front part of the lower housing 210.

In other words, the TOF sensor modules 210 of the present invention may include at least nine modules, and by being arranged in a semicircular shape, may cover 180° of the front and the floor surfaces of the autonomous mobile robot.

Meanwhile, the mounting flange 226 is coupled to a rear portion of the module casing 222 and is composed of a thin metallic panel. The mounting flange 226 is formed in an approximately “U” shape so that a cable can be seated thereon.

By being configured on the module casing 222 arranged in a semicircular shape, the mounting flange 226 is configured to enable a plurality of TOF sensors 222 to be connected to the sensing controller 300 using only a minimal amount of space.

The IMU sensor module 230 is configured on an upper portion of the lower housing 210 and is configured to detect a 3-axis gyro value and acceleration value for the floor detection device 200, so that the presence or absence of a ramp on the floor surface can be determined.

Such an IMU sensor module 230 includes a module body 232 which is coupled to the upper portion of the lower housing 210 and on one surface of which the IMU sensor 234 is mounted; the IMU sensor 234 configured to calculate values for a speed and a tilt with respect to a traveling direction of the autonomous mobile robot and transmit the calculated values to the sensing controller 300; and an upper fixing panel 235 for fixing an upper surface of the sensing controller 300.

Here, the module body 232 is configured to include module mounting grooves 236, which are seated on upper surfaces of the aforementioned first fastening shafts 214 of the lower housing 210 and to which a coupling means, such as a fastening bolt or a screw, is fastened; and shaft through-holes 238 through which the second fastening shafts 216 pass.

Such a module body 232 is coupled with the lower housing 210 in such a way that the rear portions of the TOF sensor modules 220 can be sealed.

In addition, the upper fixing panel 235 is formed to extend from one surface of the rear portion of the module body 232 and is configured at a position corresponding to the lower mounting groove 215, such that an upper surface of the sensing controller 300 is brought into close contact therewith.

Such an IMU sensor module 230 may be composed of a 3-axis angular velocity sensor (Gyroscope) and a 3-axis acceleration sensor, but is not limited thereto.

The upper housing 250 is seated on an upper portion of the IMU sensor module 230 and is configured such that both side portions thereof are coupled with the lower housing 210 by an interference fit method, thereby allowing the IMU sensor module 230 to be housed therein.

In such an upper housing 250, shaft coupling holes 252 are formed toward the front part side thereof. The shaft coupling holes 252 support coupling with the mounting housing 110 by allowing the second fastening shaft 216, which passes through the shaft through-holes 238, to further pass therethrough.

The sensing controller 300 is configured at a rear portion of the lower housing 210 and the IMU sensor module 230, and is connected to the TOF sensor 224 and the IMU sensor 234 via a wired or wireless network. The sensing controller 300 analyzes information transmitted from the TOF sensor 224 and the IMU sensor 234 to generate floor surface state information for a floor surface on which the autonomous mobile robot is traveling, such as a roadway, road surface, or indoor floor. This information includes the presence or absence of obstacles, drop-off elements, and ramps, and is transmitted to the driving controller 140.

Such a sensing controller 300 may calculate information about the movement of the autonomous mobile robot from the information transmitted from the TOF sensor 224 and the IMU sensor 234 to determine the presence or absence of obstacles and ramps on the floor surface on which the robot is traveling.

In this case, the sensing controller 300 may receive a horizontal position value of the autonomous mobile robot from the IMU sensor 234, and a difference value between the floor surface on which the robot is traveling and a front direction from the TOF sensor 224. The sensing controller 300 may analyze the received information to determine the presence or absence of an obstacle or a ramp on the floor surface on which the robot is currently traveling, generate floor surface state analysis result information corresponding to the determination result, and transmit the generated floor surface state analysis result information to the driving controller 140.

In addition, the sensing controller 300 may receive a tilt value of the autonomous mobile robot from the IMU sensor 234, analyze the received tilt value to determine whether the state of the floor surface is an upward-sloping ramp, a downward-sloping ramp, or a side ramp, generate floor surface state analysis result information corresponding to the determination result and transmit the generated floor surface state analysis result information to the driving controller 140.

Such a sensing controller 300 may be configured to be able to correct a deviation in the information transmitted from the TOF sensor 224 and the IMU sensor 234, if the deviation occurs according to the state of the floor surface, and may analyze the corrected information to determine the presence or absence of obstacles and ramps on the floor surface on which the robot is traveling.

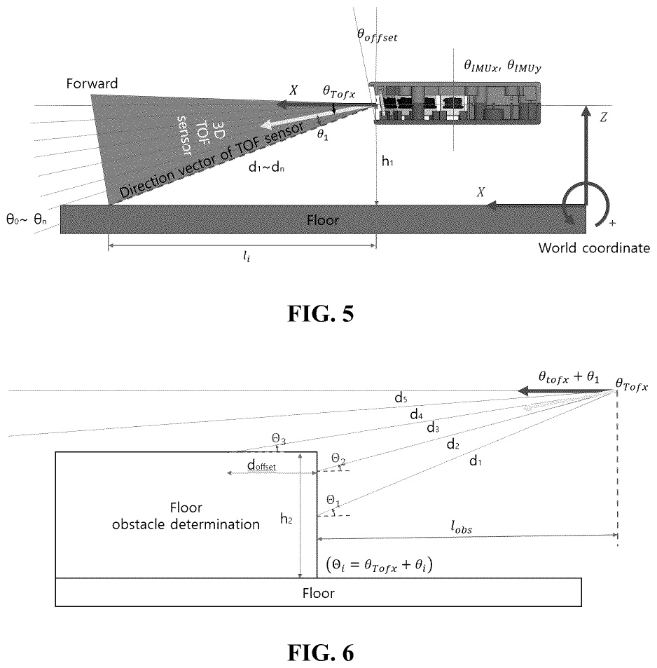

Meanwhile, as shown in FIG. 5 and the following Calculation Formula 1, the sensing controller 300 of the present invention may calculate an angle value from a viewing direction of the TOF sensor 224 to the floor surface on which the autonomous mobile robot is traveling, and transmit the calculated angle value to the driving controller 140. In this case, the driving controller 140 may output the angle value so that a setting for an inclination angle of the TOF sensor 224 can be performed.

$$\begin{matrix}Angle of viewing direction of TOF sensor \\ {( θ )}_{Tofx} = {θ}_{IMUx} + {θ}_{offset} \\ l = {d}_{l} cos ( {θ}_{Tofx} + {θ}_{l} ) ( where {l}_{l}^{2} + {h}_{1}^{2} = {d}_{l}^{2} )\end{matrix} \qquad [ Calculation Formula 1 ]$$

In addition, the sensing controller 300 of the present invention can determine whether an obstacle exists on the floor surface through FIG. 6 and the following Calculation Formula 2.

$$\begin{matrix}Obstacle determination formula \\ {l}_{obs} = {d}_{l} cos ( {Θ}_{l} ) ( where {l}_{obs}^{2} + {h}_{1}^{2} > {d}_{l} ) \\ {l}_{3} = {d}_{3} cos ( {Θ}_{3} ) = {l}_{obs} + {d}_{offset} \\ {h}_{2} = {h}_{1} - {l}_{3} tan ( {Θ}_{3} )\end{matrix} \qquad [ Calculation Formula 2 ]$$

In this case, when d₁+dₛₑₜ>d₃ or h₂>hₛₑₜ, it can be determined that the object is an obstacle that the robot cannot pass over.

In addition, the sensing controller 300 of the present invention can determine whether the floor surface on which the robot is traveling is an upward-sloping ramp through FIG. 7 and the following Calculation Formula 3.

$$\begin{matrix}Upward - sloping ramp determination formula \\ {l}_{i}^{2} + {h}_{1}^{2} > {d}_{l} \\ {d}_{s , l}^{2} = {d}_{i}^{2} + {d}_{i + 1}^{2} - 2 {d}_{i} {d}_{i + 1} cos {ΔΘ}_{i} ( where {ΔΘ}_{i} = {Θ}_{i} - {Θ}_{i + 1} ) \\ {Θ}_{s , i} = {cos}^{- 1} ( \frac{{d}_{s , l}^{2} + {d}_{i + 1}^{2} - {d}_{l}^{2}}{- 2 {d}_{s , l} {d}_{l + 1}} ) - {Θ}_{i + 1}\end{matrix} \qquad [ Calculation Formula 3 ]$$

In this case, when a constant magnitude of Θ_{s,i}=Θₛ is obtained, the sensing controller 300 can recognize the surface as an upward-sloping ramp with an angle of Θₛ.

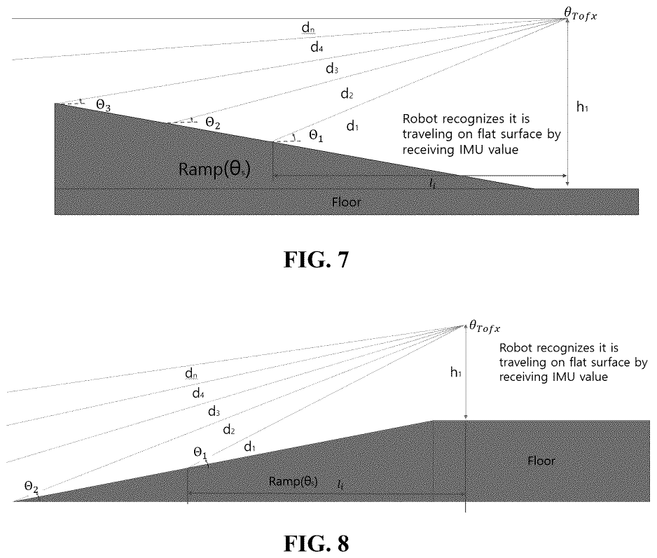

In addition, the sensing controller 300 of the present invention can determine whether the floor surface on which the robot is traveling is a downward-sloping ramp through FIG. 8 and the following Calculation Formula 4.

$$\begin{matrix}Downward - sloping ramp determination formula \\ Under the condition of {l}_{i}^{2} + {h}_{1}^{2} > {d}_{i}^{2} \\ {d}_{s , i}^{2} = {d}_{i}^{2} + {d}_{i + 1}^{2} - 2 {d}_{i} {d}_{i + 1} cos {ΔΘ}_{i} ( where {ΔΘ}_{i} = {Θ}_{i} - {Θ}_{i + 1} ) \\ {Θ}_{s , i} = {Θ}_{i + 1} - {cos}^{- 1} ( \frac{{d}_{s , i}^{2} + {d}_{i + 1}^{2} - {d}_{i}^{2}}{2 {d}_{s , i} {d}_{i + 1}} )\end{matrix} \qquad [ Calculation Formula 4 ]$$

In this case, when a constant magnitude of Θ_{s,i}=Θₛ is obtained, the sensing controller 300 can recognize the surface as a downward-sloping ramp with an angle of Θₛ.

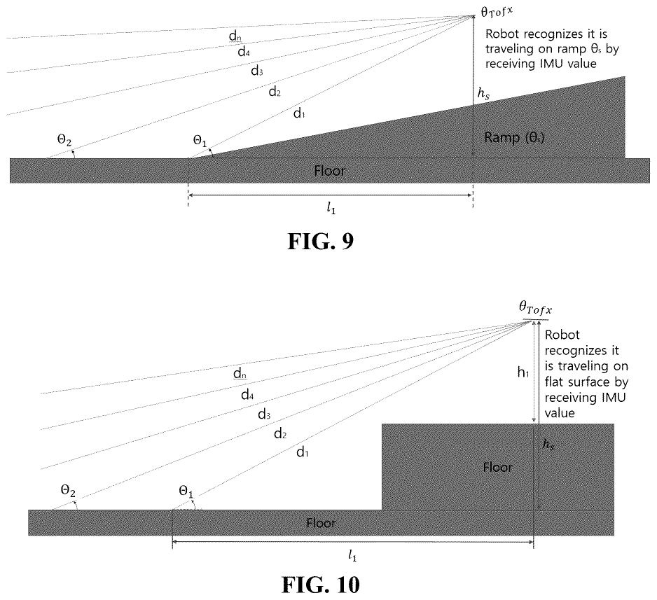

In addition, the sensing controller 300 of the present invention can determine the presence or absence of a drivable floor surface connected to a downward-sloping ramp through FIG. 9 and the following Calculation Formula 5.

$$\begin{matrix}Determination formula of drivable floor surface connected to downward - sloping ramp \\ {l}_{i} = {d}_{i} cos ( {Θ}_{i} ) ( where {l}_{i}^{2} + {h}_{1}^{2} < {d}_{i}^{2} )\end{matrix} \qquad [ Calculation Formula 5 ]$$

When hₛ=d₁ sin Θᵢ is satisfied for all Θᵢ the sensing controller 300 can determine that a drivable floor surface, which is connected to the downward-sloping ramp and is suitable for the autonomous mobile robot to travel on, exists.

In addition, the sensing controller 300 of the present invention can determine whether a cliff exists on the floor surface on which the robot is traveling through FIG. 10 and the following Calculation Formula 6.

$$\begin{matrix}cliff determination formula \\ Under the condition of {l}_{i}^{2} + {h}_{1}^{2} > {d}_{l}^{2} ,\end{matrix} \qquad [ Calculation Formula 6 ]$$

When hₛ=l₁ sin Θ₁ and hₛ−h₁>hₛₑₜ, the sensing controller 300 can determine that a cliff exists on the floor surface on which the robot is traveling.

The foregoing description is merely an exemplary illustration of the technical idea of the present invention, and it will be understood by one of ordinary skill in the art to which the present invention pertains that various modifications and variations are possible without departing from the essential characteristics of the present invention. Therefore, the embodiments disclosed in the present invention are intended not to limit the technical idea of the present invention but to describe it, and the scope of the technical idea of the present invention is not limited by these embodiments. The scope of protection of the present invention should be interpreted by the following claims, and all technical ideas within the equivalent scope should be construed as being included in the scope of the right of the present invention.

1. An autonomous mobile robot equipped with a floor detection device, comprising:
a mounting housing on which wheels and a wheel-driving means are mounted;
a driving controller for setting a driving direction and driving path of the autonomous mobile robot, and for controlling driving of the wheel-driving means; and
a floor detection device mounted at a central portion of the mounting housing, and configured to generate floor surface state analysis result information from floor surface state information comprising presence or absence of obstacles, drop-off elements or ramps on a floor surface and transmit the generated information to the driving controller;
wherein the floor detection device comprises:
a lower housing formed to have an open front part;
a plurality of TOF sensor modules mounted on the lower housing and configured to simultaneously recognize a front of the autonomous mobile robot and a floor surface on which the robot is traveling and to generate and transmit the floor surface state information;
an upper housing detachably coupled to the lower housing;
an IMU sensor module formed on an upper portion of the lower housing and configured to generate and transmit tilt information of the traveling autonomous mobile robot; and
a sensing controller configured to receive and analyze the floor surface state information and the tilt information from the TOF sensor modules and the IMU sensor module, respectively, to generate floor surface state analysis result information and transmit the generated information to the driving controller;
wherein the lower housing comprises:
a first module mounting portion on which the plurality TOF sensor modules are mounted to be arranged in a semicircular shape and to be inclined at a predetermined angle;
a plurality of first fastening shafts configured to be spaced apart from an inner side of the first module mounting portion by a predetermined interval, for supporting the IMU sensor module such that the IMU sensor module can be detachably coupled;
a second fastening shaft configured to pass through the upper housing for detachment from and coupling to the mounting housing; and
a lower mounting groove for supporting the sensing controller such that the sensing controller can be mounted and fixed.

2-3. (canceled)

4. The autonomous mobile robot according to claim 1, wherein the first module mounting portion is configured to have an inclination angle of 6° to 9°.

5. The autonomous mobile robot according to claim 1, wherein the TOF sensor modules comprise:
a module casing inserted into and fixed on the first module mounting portion;
a TOF sensor coupled to the module casing and composed of a 3D TOF array sensor; and
a mounting flange on which a cable connecting the sensing controller and the TOF sensor is mounted.

6. An autonomous mobile robot equipped with a floor detection device, comprising:
a mounting housing on which wheels and a wheel-driving means are mounted;
a driving controller for setting a driving direction and driving path of the autonomous mobile robot, and for controlling driving of the wheel-driving means; and
a floor detection device mounted at a central portion of the mounting housing, and configured to generate floor surface state analysis result information from floor surface state information comprising presence or absence of obstacles, drop-off elements or ramps on a floor surface and transmit the generated information to the driving controller;
wherein the floor detection device comprises:
a lower housing formed to have an open front part;
a plurality of TOF sensor modules mounted on the lower housing and configured to simultaneously recognize a front of the autonomous mobile robot and a floor surface on which the robot is traveling and to generate and transmit the floor surface state information;
an upper housing detachably coupled to the lower housing;
an IMU sensor module formed on an upper portion of the lower housing and configured to generate and transmit tilt information of the traveling autonomous mobile robot; and
a sensing controller configured to receive and analyze the floor surface state information and the tilt information from the TOF sensor modules and the IMU sensor module, respectively, to generate floor surface state analysis result information and transmit the generated information to the driving controller;
wherein the sensing controller receives a horizontal position value of the autonomous mobile robot from the IMU sensor module, and receives a difference value between a floor surface on which the robot is traveling and a front direction from the TOF sensor modules, and analyzes the received information to determine presence or absence of an obstacle or a ramp on the floor surface on which the robot is currently traveling.

7. The autonomous mobile robot according to claim 1, wherein the sensing controller receives a tilt value of the autonomous mobile robot from the IMU sensor module, and analyzes the received tilt value to determine whether a state of the floor surface is an upward-sloping ramp, a downward-sloping ramp, or a side ramp.

8. An autonomous mobile robot equipped with a floor detection device, comprising:
a mounting housing on which wheels and a wheel-driving means are mounted;
a driving controller for setting a driving direction and driving path of the autonomous mobile robot, and for controlling driving of the wheel-driving means; and
a floor detection device mounted at a central portion of the mounting housing, and configured to generate floor surface state analysis result information from floor surface state information comprising presence or absence of obstacles, drop-off elements or ramps on a floor surface and transmit the generated information to the driving controller;
wherein the floor detection device comprises:
a lower housing formed to have an open front part;
a plurality of TOF sensor modules mounted on the lower housing and configured to simultaneously recognize a front of the autonomous mobile robot and a floor surface on which the robot is traveling and to generate and transmit the floor surface state information;
an upper housing detachably coupled to the lower housing;
an IMU sensor module formed on an upper portion of the lower housing and configured to generate and transmit tilt information of the traveling autonomous mobile robot; and
a sensing controller configured to receive and analyze the floor surface state information and the tilt information from the TOF sensor modules and the IMU sensor module, respectively, to generate floor surface state analysis result information and transmit the generated information to the driving controller;
wherein the sensing controller is configured to calculate an angle value from a viewing direction of the TOF sensor modules to a floor surface on which the autonomous mobile robot is traveling, based on Calculation Formula 1 below, and to transmit the calculated value to the driving controller:
$$\begin{matrix}{( θ )}_{Tofx} = {θ}_{IMUx} + {θ}_{offset} \\ l = {d}_{l} cos ( {θ}_{Tofx} + {θ}_{l} ) ( where {l}_{l}^{2} + {h}_{1}^{2} = {d}_{l}^{2} ) .\end{matrix} \qquad [ Calculation Formula 1 ]$$

9. The autonomous mobile robot according to claim 1,
wherein the sensing controller determines whether an obstacle exists on a floor surface based on Calculation Formula 2 below, and
when d₁+dₛₑₜ>d₃ or h₂>hₛₑₜ, the sensing controller determines that the object is an obstacle that the robot cannot pass over:
$$\begin{matrix}{l}_{obs} = {d}_{l} cos ( {Θ}_{l} ) ( where {l}_{obs}^{2} + {h}_{1}^{2} > {d}_{l} ) \\ {l}_{3} = {d}_{3} cos ( {Θ}_{3} ) = {l}_{obs} + {d}_{offset} \\ {h}_{2} = {h}_{1} - {l}_{3} tan ( {Θ}_{3} ) .\end{matrix} \qquad [ Calculation Formula 2 ]$$

10. The autonomous mobile robot according to claim 1,
wherein the sensing controller determines whether a floor surface on which the robot is traveling is an upward-sloping ramp based on Calculation Formula 3 below, and,
when a constant magnitude of Θ_{s,i}=Θₛ is obtained, the sensing controller recognizes the surface as an upward-sloping ramp with an angle of Θₛ:
$$\begin{matrix}Under a condition of \\ {l}_{i}^{2} + {h}_{1}^{2} > {d}_{l} \\ {d}_{s , l}^{2} = {d}_{i}^{2} + {d}_{i + 1}^{2} - 2 {d}_{i} {d}_{i + 1} cos {ΔΘ}_{i} ( where {ΔΘ}_{i} = {Θ}_{i} - {Θ}_{i + 1} ) \\ {Θ}_{s , i} = {cos}^{- 1} ( \frac{{d}_{s , l}^{2} + {d}_{i + 1}^{2} - {d}_{l}^{2}}{- 2 {d}_{s , l} {d}_{l + 1}} ) - {Θ}_{i + 1} .\end{matrix} \qquad [ Calculation Formula 3 ]$$

11. The autonomous mobile robot according to claim 1, wherein the sensing controller determines whether a floor surface on which the robot is traveling is a downward-sloping ramp based on Calculation Formula 4 below, and
when a constant magnitude of Θ_{s,i}=θₛ is obtained, the sensing controller recognizes the surface as a downward-sloping ramp with an angle of Θₛ.
$$\begin{matrix}Under a condition of {l}_{i}^{2} + {h}_{1}^{2} < {d}_{i}^{2} \\ {d}_{s , i}^{2} = {d}_{i}^{2} + {d}_{i + 1}^{2} - 2 {d}_{i} {d}_{i + 1} cos {ΔΘ}_{i} ( where {ΔΘ}_{i} = {Θ}_{i} - {Θ}_{i + 1} ) \\ {Θ}_{s , i} = {Θ}_{i + 1} - {cos}^{- 1} ( \frac{{d}_{s , i}^{2} + {d}_{i + 1}^{2} - {d}_{i}^{2}}{2 {d}_{s , i} {d}_{i + 1}} ) .\end{matrix} \qquad [ Calculation Formula 4 ]$$

12. The autonomous mobile robot according to claim 1, wherein the sensing controller determines presence or absence of a drivable floor surface connected to a downward-sloping ramp based on Calculation Formula 5 below, and when hₛ=d₁ sin Θᵢ is satisfied for all Θᵢ, the sensing controller determines that a drivable floor surface connected to the downward-sloping ramp exists:
$${l}_{i} = {d}_{i} cos ( {Θ}_{i} ) ( where {l}_{i}^{2} + {h}_{1}^{2} < {d}_{i}^{2} ) . \qquad [ Calculation Formula 5 ]$$

13. The autonomous mobile robot according to claim 1, wherein the sensing controller determines whether a cliff exists on a floor surface on which the robot is traveling through Calculation Formula 6 below:
$$\begin{matrix}Under a condition of \\ {l}_{i}^{2} + {h}_{1}^{2} > {d}_{i}^{2} , \\ {h}_{s} = {l}_{i} sin {Θ}_{i} , and {h}_{s} - {h}_{1} > {h}_{set} .\end{matrix} \qquad [ Calculation Formula 6 ]$$
